(19) United States
(12) Patent Application Publication
(10) Pub. No.: US 2008/0112095 A1
(43) Pub. Date: May 15, 2008

(54) DUAL CURRENT-PERPENDICULAR-TO-THE-PLANE (CPP) MAGNETORESISTIVE SENSOR WITH HEUSLER ALLOY FREE LAYER AND MINIMAL CURRENT-INDUCED NOISE

(75) Inventors: Matthew J. Carey, San Jose, CA (US); Jeffrey R. Childress, San Jose, CA (US); Stefan Maat, San Jose, CA (US)

Correspondence Address: THOMAS R. BERTHOLD, 18938 CONGRESS JUNCTION COURT, SARATOGA, CA, 95070, US

(73) Assignee: HITACHI GLOBAL STORAGE TECHNOLOGIES NETHERLANDS B.V., San Jose, CA (US)

(21) Appl. No.: 11/560,199

(22) Filed: Nov. 15, 2006

(51) Int. Cl. G11B 5/127; G11B 5/33

(52) U.S. Cl. 360/324.12

(57) ABSTRACT

A dual current-perpendicular-to-the-plane (CPP) magnetoresistive sensor has a free ferromagnetic layer formed of a Heusler alloy and each of the pinned ferromagnetic layers formed of a ferromagnetic material other than a Heusler alloy, like a conventional CoFe or NiFe material. The Heusler alloy material in the free layer may be a known Heusler alloy material or an alloy with a composition substantially the same as that of a known Heusler alloy, and which results in high magnetoresistance due to enhanced spin polarization and/or enhanced spin-dependent scattering compared to conventional ferromagnetic materials. Each of the two pinned ferromagnetic layers may be an antiparallel (AP) pinned structure wherein first (AP1) and second (AP2) ferromagnetic layers are separated by a nonmagnetic antiparallel coupling (APC) layer with the magnetization directions AP1 and AP2 layers oriented substantially antiparallel. Each AP2 layer is adjacent one of the two nonmagnetic spacer layers in the dual CPP sensor and is formed of a ferromagnetic material other than a Heusler alloy.

### BACKGROUND OF THE INVENTION

1. Field of the Invention

The invention relates generally to a current-perpendicular-to-the-plane (CPP) magnetoresistive (MR) sensor that operates with the sense current directed perpendicularly to the planes of the layers making up the sensor stack, and more particularly to a dual CPP sensor with a Heusler alloy free layer and low current-induced noise.

2. Background of the Invention

One type of conventional MR sensor used as the read head in magnetic recording disk drives is a “spin-valve” (SV) sensor. A SV MR sensor has a stack of layers that includes two ferromagnetic layers separated by a nonmagnetic electrically conductive spacer layer, which is typically copper (Cu). One ferromagnetic layer has its magnetization direction fixed, such as by being pinned by exchange coupling with an adjacent antiferromagnetic layer, and the other ferromagnetic layer has its magnetization direction “free” to rotate in the presence of an external magnetic field. With a sense current applied to the sensor, the rotation of the free-layer magnetization relative to the fixed-layer magnetization is detectable as a change in electrical resistance (ΔR), with the measure of the output of the sensor, or its magnetoresistance, being ΔR/R.

In a magnetic recording disk drive SV read sensor or head, the stack of layers are located in the read “gap” between magnetic shields. The magnetization of the fixed or pinned layer is generally perpendicular to the plane of the disk, and the magnetization of the free layer is generally parallel to the plane of the disk in the absence of an external magnetic field. When exposed to an external magnetic field from the recorded data on the disk, the free-layer magnetization will rotate, causing a change in electrical resistance. If the sense current flowing through the SV is directed parallel to the planes of the layers in the sensor stack, the sensor is referred to as a current-in-the-plane (CIP) sensor, while if the sense current is directed perpendicular to the planes of the layers in the sensor stack, it is referred to as current-perpendicular-to-the-plane (CPP) sensor.

CPP-SV read heads are described by A. Tanaka et al., “Spin-valve heads in the current-perpendicular-to-plane mode for ultrahigh-density recording”, IEEE TRANSACTIONS ON MAGNETICS, 38 (1): 84-88 Part 1 January 2002. Another type of CPP sensor is a magnetic tunnel junction (MTJ) sensor, also called a tunneling MR (TMR) sensor, in which the nonmagnetic spacer layer is a very thin nonmagnetic tunnel barrier layer. In a TMR read head the nonmagnetic spacer layer is an electrically insulating material, such as TiO₂, MgO or Al₂O₃, while in a CPP-SV MR read head the nonmagnetic spacer layer is formed of an electrically conductive material such as Cu.

Conventional ferromagnetic materials, such as NiFe and CoFe alloys, have typically been used for the free and pinned layers in both CIP and CPP sensors. However, as the density and bandwidth of recording devices increase, there is a need to increase the magnetoresistance of the sensor. Ferromagnetic Heusler alloys have been investigated for use in the ferromagnetic free and pinned layers of CPP sensors because they are known to have high spin-polarization. A Heusler alloy is a metal alloy based on a Heusler phase. Heusler phases are intermetallics with particular composition and crystal structure. A perfect ferromagnetic Heusler alloy with 100% spin-polarization will result in large magnetoresistance when incorporated into a CPP spin-valve sensor.

However, the high spin polarization of Heusler alloys in the free and pinned layers increases the susceptibility of CPP sensors to current-induced noise and instability. CPP sensors in general are susceptible to current-induced noise and instability because the spin-polarized current flows perpendicularly through the ferromagnetic layers and produces a spin transfer torque on the local magnetization. This can produce continuous gyrations of the magnetization, resulting in substantial low-frequency magnetic noise if the sense current is above a certain level. This effect is described by J.-G. Zhu et al., “Spin transfer induced noise in CPP read heads,” IEEE TRANSACTIONS ONMAGNETICS, Vol. 40, pp. 182-188, January 2004. This undesirable effect generally increases with ferromagnetic materials that have high spin-polarization, like Heusler alloys.

It has been demonstrated that dual CPP-SV sensors may reduce the sensitivity of the free layer to spin-torque-induced instability. (J. R. Childress et al., “Dual current-perpendicular-to-plane giant magnetoresistive sensors for magnetic recording heads with reduced sensitivity to spin-torque-induced noise” J. Appl. Phys. Vol. 99, 08S305, 2006). Dual CPP sensors are well-known. In a dual CPP sensor a second spacer layer is located on the other side of the free layer and a second pinned layer is located on the second spacer layer. U.S. Pat. No. 5,668,688 describes a dual CPP-SV sensor.

US2005/0073778 A1 describes a dual CPP-SV sensor with a Heusler alloy in both the free layer and both pinned layers. However, such a sensor still exhibits undesirable current-induced noise. In particular, noise caused by spin-torque instability of the pinned layers can be a problem.

What is needed is a dual CPP sensor that takes advantage of the high spin-polarization of Heusler alloys but produces minimal current-induced noise without loss of magnetoresistance or sensor resolution.

### SUMMARY OF THE INVENTION

The invention is a dual CPP sensor wherein the free ferromagnetic layer is formed of a Heusler alloy and each of the pinned ferromagnetic layers is required to be formed of a ferromagnetic material other than a Heusler alloy, like a conventional CoFe or NiFe material. The Heusler alloy material in the free layer may be a known ferromagnetic Heusler alloy material or an alloy with a composition substantially the same as that of a known Heusler alloy, and which results in high magnetoresistance due to enhanced spin polarization and/or enhanced spin-dependent scattering compared to conventional ferromagnetic materials. Each of the two pinned ferromagnetic layers may be an antiparallel (AP) pinned structure wherein first (AP1) and second (AP2) ferromagnetic layers are separated by a nonmagnetic antiparallel coupling (APC) layer with the magnetization directions AP1 and AP2 layers oriented substantially antiparallel. Each AP2 layer is adjacent to one of the two nonmagnetic spacer layers in the dual CPP sensor. The AP2 layers are required to be formed of a ferromagnetic material other than a Heusler alloy. The dual CPP sensor has a higher ΔRA (product of the change in resistance times the cross-sectional area) and lower susceptibility to spin-torque induced noise at a given current density than a dual CPP sensor with a Heusler alloy material in both the free and pinned layers, and thus achieves a higher signal-to-noise ratio (SNR).

For a fuller understanding of the nature and advantages of the present invention, reference should be made to the following detailed description taken together with the accompanying figures.

### BRIEF DESCRIPTION OF THE DRAWINGS

FIG. 1 is a schematic top view of a conventional magnetic recording hard disk drive with the cover removed.

FIG. 2 is an enlarged end view of the slider and a section of the disk taken in the direction 2-2 in FIG. 1.

FIG. 3 is a view in the direction 3-3 of FIG. 2 and shows the ends of the read/write head as viewed from the disk.

FIG. 4 is a cross-sectional schematic view of a conventional dual CPP-SV read head showing the stack of layers located between the magnetic shield layers.

FIG. 5 is a graph comparing ΔR as a function of current density for a first test structure of a single CPP-SV with both the free layer and the single AP2 layer being formed of a Heusler to a second test structure of a single CPP-SV with the free layer being formed of a Heusler alloy and the single AP2 layer being formed of a conventional ferromagnetic alloy.

FIG. 6 is a cross-sectional schematic view of the free layer and AP-pinned layers in a dual CPP-SV read head according to this invention.

### DETAILED DESCRIPTION OF THE INVENTION

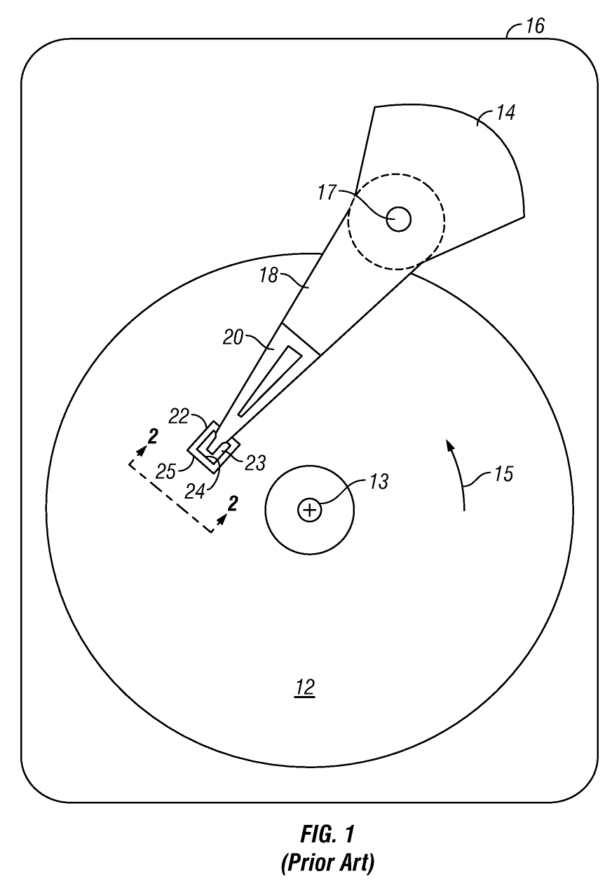

The dual CPP read head according to this invention has application for use in a magnetic recording disk drive, the operation of which will be briefly described with reference to FIGS. 1-3. FIG. 1 is a block diagram of a conventional magnetic recording hard disk drive. The disk drive includes a magnetic recording disk 12 and a rotary voice coil motor (VCM) actuator 14 supported on a disk drive housing or base 16. The disk 12 has a center of rotation 13 and is rotated in direction 15 by a spindle motor (not shown) mounted to base 16. The actuator 14 pivots about axis 17 and includes a rigid actuator arm 18. A generally flexible suspension 20 includes a flexure element 23 and is attached to the end of arm 18. A head carrier or air-bearing slider 22 is attached to the flexure 23. A magnetic recording read/write head 24 is formed on the trailing surface 25 of slider 22. The flexure 23 and suspension 20 enable the slider to “pitch” and “roll” on an air-bearing generated by the rotating disk 12. Typically, there are multiple disks stacked on a hub that is rotated by the spindle motor, with a separate slider and read/write head associated with each disk surface.

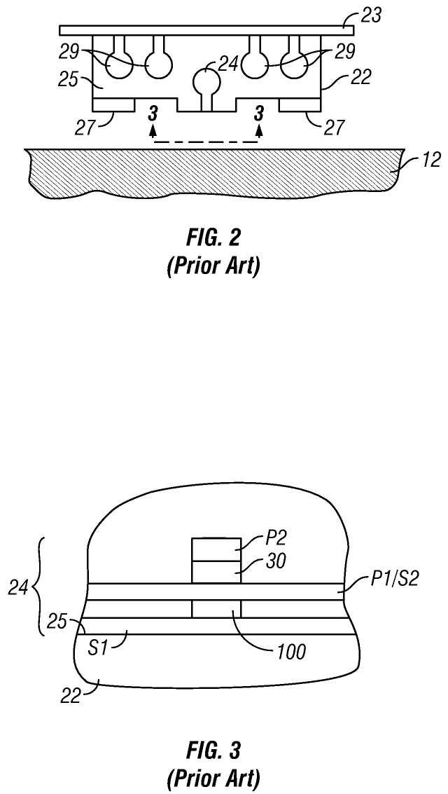

FIG. 2 is an enlarged end view of the slider 22 and a section of the disk 12 taken in the direction 2-2 in FIG. 1. The slider 22 is attached to flexure 23 and has an air-bearing surface (ABS) 27 facing the disk 12 and a trailing surface 25 generally perpendicular to the ABS. The ABS 27 causes the airflow from the rotating disk 12 to generate a bearing of air that supports the slider 22 in very close proximity to or near contact with the surface of disk 12. The read/write head 24 is formed on the trailing surface 25 and is connected to the disk drive read/write electronics by electrical connection to terminal pads 29 on the trailing surface 25.

FIG. 3 is a view in the direction 3-3 of FIG. 2 and shows the ends of read/write head 24 as viewed from the disk 12. The read/write head 24 is a series of thin films deposited and lithographically patterned on the trailing surface 25 of slider 22. The write head includes magnetic write poles P1/S2 and P1 separated by a write gap 30. The dual CPP MR sensor or read head 100 is located between two magnetic shields S1 and P1/S2, with P1/S2 also serving as the first write pole for the write head. The shields S1, S2 are formed of magnetically permeable material and are electrically conductive so they can function as the electrical leads to the read head 100. Separate electrical leads may also be used, in which case the read head 100 is formed in contact with layers of electrically conducting lead material, such as tantalum, gold, or copper, that are in contact with the shields S1, S2.

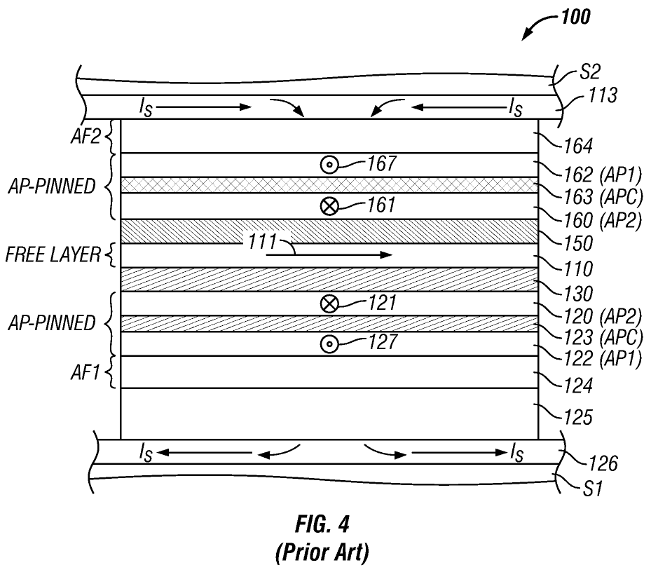

FIG. 4 is an enlarged sectional view showing the layers making up sensor 100 as seen from the air bearing surface (ABS) of the sensor. Sensor 100 is a dual CPP-SV read head comprising a stack of layers formed between the two magnetic shield layers S1, S2 that are typically electroplated NiFe alloy films. The lower shield S1 is typically polished by chemical-mechanical polishing (CMP) to provide a smooth substrate for the growth of the sensor stack. This may leave an oxide coating which can be removed with a mild etch just prior to sensor deposition. The sensor layers include a first pinned ferromagnetic layer 120 having a fixed magnetic moment or magnetization direction 121 oriented substantially perpendicular to the ABS (into the page); a free ferromagnetic layer 110 having a magnetic moment or magnetization direction 111 that is oriented substantially parallel to the ABS and that can rotate in the plane of layer 110 in response to transverse external magnetic fields from the disk 12; a first electrically conducting spacer layer 130, typically copper (Cu), between the pinned layer 120 and the free layer 110; a second pinned ferromagnetic layer 160 having a fixed magnetic moment or magnetization direction 161 oriented substantially perpendicular to the ABS (into the page); and a second electrically conducting spacer layer 150 between the pinned layer 160 and the free layer 110.

Each of the two pinned ferromagnetic layers in a dual CPP-SV sensor may be a single pinned layer or an antiparallel (AP) pinned structure. An AP-pinned structure has first (AP1) and second (AP2) ferromagnetic layers separated by a nonmagnetic antiparallel coupling (APC) layer with the magnetization directions of the two AP-pinned ferromagnetic layers oriented substantially antiparallel. The AP2 layer, which is in contact with the nonmagnetic APC layer on one side and the sensor's electrically conducting spacer layer on the other side, is typically referred to as the reference layer. The AP1 layer, which is typically in contact with an antiferromagnetic or hard magnet pinning layer on one side and the nonmagnetic APC layer on the other side, is typically referred to as the pinned layer. Instead of being in contact with a hard magnetic layer, AP1 by itself can be comprised of hard magnetic material so that AP1 is in contact with an underlayer on one side and the nonmagnetic APC layer on the other side. The AP-pinned structure minimizes the net magnetostatic coupling between the reference/pinned layers and the free ferromagnetic layer. The AP-pinned structure, also called a “laminated” pinned layer, and sometimes called a synthetic antiferromagnet (SAF), is described in U.S. Pat. No. 5,465,185.

Each of the pinned layers in the dual CPP-SV sensor in FIG. 4 is an AP-pinned structure. The “bottom” AP-pinned structure between free layer 110 and S1 will be described, but the description is fully applicable to the “top” AP-pinned structure. For example, the bottom AP-pinned structure includes a first ferromagnetic layer 122 (AP1) and a second ferromagnetic layer 120 (AP2) that are antiferromagnetically coupled across an AP coupling (APC) layer 123. The APC layer 123 is typically Ru, Ir, Rh, Cr or alloys thereof. The AP1 and AP2 ferromagnetic layers have their respective magnetization directions 127, 121 oriented antiparallel. The AP1 layer 122 may have its magnetization direction pinned by being exchange-coupled to an antiferromagnetic (AF) layer 124 as shown in FIG. 4. Alternatively, the AP-pinned structure may be “self-pinned” or it may be pinned by a hard magnetic layer such as Co₁₀₀₋ₓPtₓ or Co_{100-x-y}PtₓCr_{y} (where x is about between 8 and 30 atomic percent). Instead of being in contact with a hard magnetic layer, AP1 by itself can be comprised of hard magnetic material so that AP1 is in contact with an underlayer on one side and the nonmagnetic APC layer on the other side. In a “self pinned” sensor the AP1 and AP2 layer magnetization directions 127, 121 are typically set generally perpendicular to the disk surface by magnetostriction and the residual stress that exists within the fabricated sensor, and no AF pinning layer is required. It is desirable that the AP1 and AP2 layers have similar moments. This assures that the net magnetic moment of the AP-pinned structure is small so that magneto-static coupling to the free layer is minimized and the effective pinning field of the AF layer 124, which is approximately inversely proportional to the net magnetization of the AP-pinned structure, remains high. In the case of a hard magnet pinning layer, the hard magnet pinning layer moment needs to be accounted for when balancing the moments of AP1 and AP2 to minimize magneto-static coupling to the free layer. The top AP-pinned structure includes AP2 layer 160 with magnetization direction 161, APC layer 163, and AP1 layer 162, with AP1 layer 162 having its magnetization direction 167 pinned by being exchange-coupled to a AF layer 164.

Located between the lower shield layer S1 and the bottom AP-pinned structure are the bottom electrical lead 126 and a seed layer 125. The seed layer 125 may be a single layer or multiple layers of different materials. Located between the top AF layer 164 and the upper shield layer S2 are a capping layer 112 and the top electrical lead 113. The capping layer 112 may be a single layer or multiple layers of different materials, such as a Cu/Ru/Ta trilayer.

In the presence of an external magnetic field in the range of interest, i.e., magnetic fields from recorded data on the disk 12, the magnetization direction 111 of free layer 110 will rotate while the magnetization directions 121, 161 of reference layers 120, 160, respectively, will remain substantially fixed and not rotate. The rotation of the free-layer magnetization 111 relative to the reference-layer magnetizations 121, 161 results in a change in electrical resistance. Hence, when a sense current I_{S} is applied between top lead 113 and bottom lead 126, the resistance change is detected as a voltage signal proportional to the strength of the magnetic signal fields from the recorded data on the disk.

The leads 126, 113 are typically Ta or Rh. However, any low resistance material may also be used. They are optional and used to adjust the shield-to-shield spacing. If the leads 126 and 113 are not present, the bottom and top shields S1 and S2 are used as leads. The seed layer 125 is typically one or more layers of NiFeCr, NiFe, Ta, Cu or Ru. The AF layers 124, 164 are typically a Mn alloy, e.g., PtMn, NiMn, FeMn, IrMn, IrMnCr, PdMn, PtPdMn or RhMn. If a hard magnetic layer is used instead of an AF layer it is typically a CoPt or FePt alloy, for example CoPtCr, in which case a Cr or Cr-alloy seed layer is often used below the hard magnetic layer. The capping layer 112 provides corrosion protection and is typically formed of Ru or Ta.

In the conventional dual CPP-SV sensor the ferromagnetic layers 122 (AP1), 162 (AP1), 120 (AP2), 160 (AP2) and 110 (free layer) are typically formed of crystalline CoFe or NiFe alloys, or a multilayer of these materials, such as a CoFe/NiFe bilayer. The AP2 layers can also be laminated structures to obtain a high degree of spin-dependent interface scattering. For example the AP2 layers can be a FM/XX/FM/ . . . /XX/FM laminate, where the ferromagnetic (FM) layers are formed of Co, Fe or Ni, one of their alloys, or a multilayer of these materials, such as a CoFe—NiFe—CoFe trilayer; and the XX layers are nonmagnetic layers, typically Cu, Ag, or Au or their alloys, and are thin enough that the adjacent FM layers are strongly ferromagnetically coupled.

For example, the AP2 layers may be a CoFe alloy, typically 10 to 40 Å thick, and the free ferromagnetic layer 110 may be a trilayer of a CoFe alloy/NiFe alloy/CoFe alloy where the CoFe alloys are typically 5-15 Å thick, and the NiFe alloy is typically 10-30 Å thick. The APC layers in the AP-pinned structures are typically Ru or Ir with a thickness between about 4-10 Å.

A hard magnetic bias layer (not shown), such as a CoPt or CoCrPt layer, may also be included outside the sensor stack near the side edges of the free ferromagnetic layer 110 or in the stack for magnetic stabilization or longitudinal biasing of the free ferromagnetic layer magnetization 111.

In this invention, the magnetoresistance of the conventional dual CPP-SV as described above was sought to be improved by substituting the conventional ferromagnetic materials used in the AP2 and free layers with a Heusler alloy, which is known to have high spin-polarization in its bulk form. A Heusler alloy is a ferromagnetic metal alloy based on a Heusler phase. Heusler phases are intermetallics with particular composition and crystal structure. Examples of Heusler alloys include but are not limited to the full Heusler alloys CO₂MnX (where X is Al, Sb, Si, Sn, Ga, or Ge). Examples also include but are not limited to the half Heusler alloys NiMnSb, PtMnSb, and CO₂FeₓCr₍₁₋ₓ₎Al (where x is between 0 and 1). A perfect Heusler alloy with 100% spin-polarization will result in large magnetoresistance when incorporated into a CPP spin-valve sensor. However it is possible that in a thin-film form and at finite temperatures, the crystal structure of the Heusler alloy may deviate from its optimal structure and that the spin polarization will decrease. Nevertheless, a high magnetoresistance can still be obtained as long as the spin polarization exceeds that of conventional ferromagnetic alloys, or if spin-dependent scattering in the Heusler alloy is high. Therefore in this invention and as used herein a “Heusler alloy” shall mean an alloy with a composition substantially the same as that of a known Heusler alloy, and which results in high magnetoresistance due to enhanced spin polarization and/or enhanced spin-dependent scattering compared to conventional ferromagnetic materials such as NiFe and CoFe alloys.

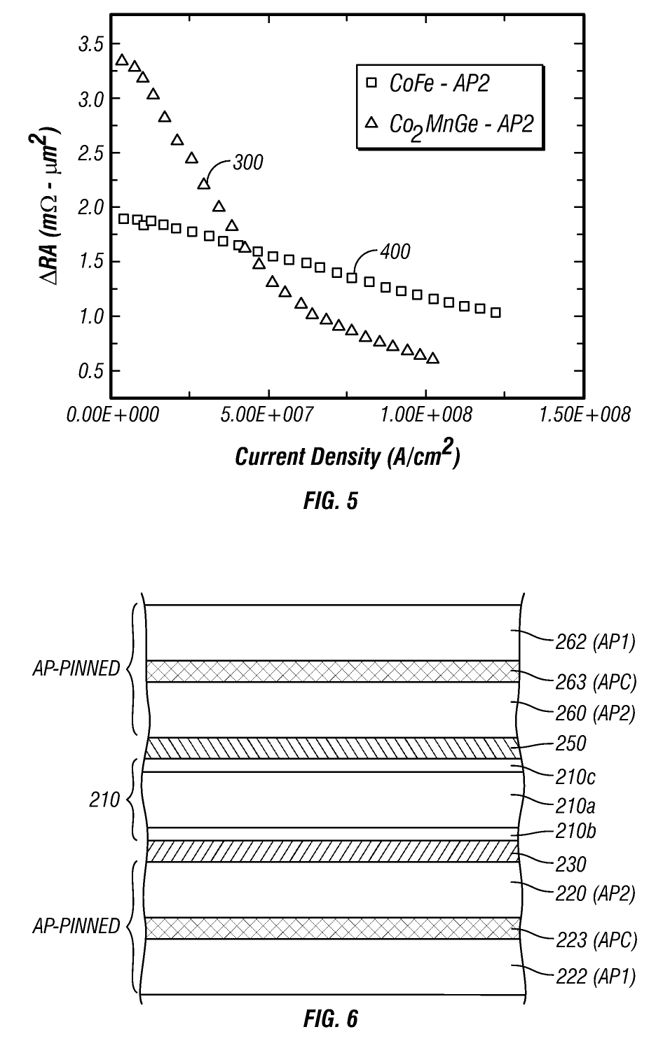

A test structure of a single CPP-SV was fabricated with both the free layer and the single AP2 layer being formed of the Heusler alloy CO₂MnGe. This device was patterned into a stack with a 50 nm diameter cross section. The ΔRA (product of the change in resistance times the cross-sectional area) of this test structure was measured as a function of current density and is shown as curve 300 in FIG. 5. The structure gives a high ΔRA of 3.3 mΩ-μm² at low current density, but the ΔRA decreases rapidly to about 0.5 mΩ-μm² at a current density of about 10⁸ A/cm². The sensor output voltage ΔV is proportional to ΔRA*(current density). In typical CPP sensors ΔV is required to be at least about 1 mV. At 10⁸A/cm², this device would produce about 0.5 mV. Thus the results shown by curve 300 in FIG. 5 demonstrate that a sensor with a Heusler alloy in both the free layer and AP2 layer would have insufficient signal.

Equally important is the noise generated by the sensor. The rapid drop in ΔRA observed for this sensor is due to the onset of spin-torque oscillations of the magnetization of the free layer. These oscillations result in noise in the output ΔV. Thus, the signal-to-noise ratio (SNR) will be even more degraded than expected by the lower ΔRA alone. This has been confirmed by resistance-field high frequency noise measurements taken at increasing bias voltage. For a test structure of a single CPP-SV with a CO₂MnGe Heusler alloy in both the free and pinned layer, noise appears at a current density about one-tenth the current density at which it appears for a test structure of a single CPP-SV test structure with conventional CoFe alloy free and pinned layers.

A test structure of a single CPP-SV was then fabricated with the free layer material being primarily CO₂MnGe and the single AP2 layer material being other than a Heusler alloy, i.e., a conventional ferromagnetic CO₅₀Fe₅₀ alloy. The ΔRA of this test structure was measured as a function of current density and is shown as curve 400 in FIG. 5. The structure gives a lower ΔRA than the test structure shown by curve 300 at low current density, but the ΔRA decreases much less rapidly. At a current density of about 5×10⁷ A/cm² this test structure shows a higher ΔRA than the test structure shown by curve 300. This, together with the lower susceptibility to spin torque noise at a given current density, results in higher SNR.

FIG. 6 is a schematic cross section of the free layer and two AP-pinned layers in a dual CPP-SV according to the present invention. The bottom AP-pinned structure includes AP1 layer 222, APC layer 223 and AP2 layer 220; and the top AP-pinned structure includes AP1 layer 262, APC layer 263 and AP2 layer 260. Bottom electrically conducting spacer layer 230 is located between the free layer 210 and bottom AP2 layer 220; and top electrically conducting spacer layer 250 is located between the free layer 210 and top AP2 layer 260. In this invention, the free layer 210 is formed of a Heusler alloy, for example CO₂MnGe, and the AP2 layers 220, 260 are each required to be formed of a ferromagnetic material other than a Heusler alloy, such as a conventional ferromagnetic material like a CoFe or NiFe alloy. If the free layer is primarily CO₂MnX, where X is for example Ge, the free layer may also include portions where one or more of the other possible elements, i.e., Al, Sb, Si, Sn and Ga, are substituted in the crystal structure for the Ge.

The free layer 210 is preferably a laminated free layer comprising a Heusler alloy layer 210a between ferromagnetic “nanolayers” or sublayers 210b, 210c. Layer 210a has a thickness in the range of about 20 Å to 80 Å and each of the sublayers 210b, 210c has a thickness less than about 15 Å. The sublayers may be formed of a conventional ferromagnetic material, for example CO₅₀Fe₅₀. This type of laminated free layer for a single CPP-SV sensor is described by Hoshiya et al., “Current-perpendicular-to-the-plane giant magnetoresistance in structures with half-metal materials laminated between CoFe layers”, J. Appl. Phys., Vol. 95, No. 11, Part 2, 1 Jun. 2004, pp. 6774-6776.

The laminated free layer 210 may also include nonmagnetic spacer layers between 210a and 210b and/or 210a and 210c to enhance interface scattering. These nonmagnetic spacer layers should be thin enough to ferromagnetically couple 210a and 210b, and 210a and 210c, respectively. For example a 3-5 Å Cu layer may be used for the nonmagnetic spacer layers.

While the invention has been described with respect to a dual CPP-SV read head, the invention is applicable to other types of dual CPP sensors, such as a dual TMR read head.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A magnetoresistive sensor capable of sensing external magnetic fields when a sense current is applied perpendicular to the planes of the layers in the sensor, the sensor comprising:
a substrate;
a first ferromagnetic pinned layer on the substrate and having an in-plane magnetization direction, the first pinned layer being formed of a ferromagnetic material other than a Heusler alloy;
a first nonmagnetic spacer layer on the first pinned layer;
a free ferromagnetic layer on the first spacer layer and having an in-plane magnetization direction oriented substantially orthogonal to the magnetization direction of the first pinned layer in the absence of an applied magnetic field, the free layer comprising a ferromagnetic Heusler alloy;
a second nonmagnetic spacer layer on the free layer; and
a second ferromagnetic pinned layer on the second spacer layer and having an in-plane magnetization direction substantially orthogonal to the magnetization direction of the free layer in the absence of an applied magnetic field, the second pinned layer being formed of a ferromagnetic material other than a Heusler alloy.

2. The sensor of claim 1 wherein the free layer comprises a ferromagnetic Heusler alloy selected from the group consisting of CO₂MnX (where X is selected from the group consisting of Al, Sb, Si, Sn, Ga, and Ge), NiMnSb, PtMnSb, and CO₂FeₓCr₍₁₋ₓ₎Al (where x is between 0 and 1).

3. The sensor of claim 1 wherein the free layer comprises first and second CoFe alloy sublayers and a Heusler alloy layer between and in contact with the first and second sublayers.

4. The sensor of claim 1 wherein:
the first pinned layer is a first antiparallel (AP) pinned structure comprising a first AP-pinned (AP1) ferromagnetic layer having an in-plane magnetization direction, a second AP-pinned (AP2) ferromagnetic reference layer formed of a material other than a Heusler alloy and having an in-plane magnetization direction substantially antiparallel to the magnetization direction of the AP1 layer, and an AP coupling (APC) layer between and in contact with the AP1 and AP2 layers;
the first nonmagnetic spacer layer is on the AP2 layer of the first AP pinned structure;
the second pinned layer is a second antiparallel (AP) pinned structure comprising a first AP-pinned (AP1) ferromagnetic layer having an in-plane magnetization direction, a second AP-pinned (AP2) ferromagnetic reference layer formed of a material other than a Heusler alloy and having an in-plane magnetization direction substantially antiparallel to the magnetization direction of the AP1 layer, and an AP coupling (APC) layer between and in contact with the AP1 and AP2 layers; and
the AP2 layer of the second AP pinned structure is on the second spacer layer.

5. The sensor of claim 4 wherein each of the first and second AP-pinned structures is a self-pinned structure.

6. The sensor of claim 4 further comprising a first antiferromagnetic layer exchange-coupled to the AP1 layer of the first AP-pinned structure for pinning the magnetization direction of the AP1 layer of the first AP-pinned structure, and a second antiferromagnetic layer exchange-coupled to the AP1 layer of the second AP-pinned structure for pinning the magnetization direction of the AP1 layer of the second AP-pinned structure.

7. The sensor of claim 1 wherein each of the first and second spacer layers is formed of electrically conducting material and wherein the sensor is a dual current-perpendicular-to-the-plane (CPP) spin-valve sensor.

8. The sensor of claim 1 wherein each of the first and second spacer layers is formed of electrically insulating material and wherein the sensor is a dual tunneling magnetoresistive (TMR) sensor.

9. The sensor of claim 1 wherein the sensor is a magnetoresistive read head for reading magnetically recorded data from tracks on a magnetic recording medium, and wherein the substrate is a first shield formed of magnetically permeable material.

10. A dual current-perpendicular-to-the-plane (CPP) spin-valve magnetoresistive read head for reading magnetically recorded data from tracks on a magnetic recording medium, the head comprising:
a first shield layer of magnetically permeable material;
a first antiparallel (AP) pinned structure on the first shield layer and comprising a first ferromagnetic (AP1) layer having an in-plane magnetization direction, a second ferromagnetic (AP2) reference layer having an in-plane magnetization direction substantially antiparallel to the magnetization direction of the AP1 layer, and an AP coupling (APC) layer between and in contact with the AP1 and AP2 layers, the AP2 layer being a material other than a Heusler alloy;
a first electrically conductive nonmagnetic spacer layer on the AP2 layer of the first AP-pinned structure;
a free ferromagnetic layer on the first spacer layer and having an in-plane magnetization direction oriented substantially orthogonal to the magnetization directions of the AP1 and AP2 layers of the first AP-pinned structure in the absence of an external magnetic field, the free layer comprising a ferromagnetic Heusler alloy;
a second electrically conductive nonmagnetic spacer layer on the free layer;
a second antiparallel (AP) pinned structure comprising a first ferromagnetic (AP1) layer having an in-plane magnetization direction, a second ferromagnetic (AP2) reference layer having an in-plane magnetization direction substantially antiparallel to the magnetization direction of the AP1 layer, the magnetization directions of the AP1 and AP2 layers being substantially orthogonal to the magnetization direction of the free layer in the absence of an external magnetic field, and an AP coupling (APC) layer between and in contact with the AP1 and AP2 layers, the AP2 layer being on the second spacer layer and being a material other than a Heusler alloy;
a capping layer on the AP1 layer of the second AP-pinned structure; and
a second shield layer of magnetically permeable material on the capping layer.

11. The head of claim 10 wherein the free layer comprises a ferromagnetic Heusler alloy selected from the group consisting of CO₂MnX (where X is selected from the group consisting of Al, Sb, Si, Sn, Ga, and Ge), NiMnSb, PtMnSb, and CO₂FeₓCr₍₁₋ₓ₎Al (where x is between 0 and 1).

12. The head of claim 10 wherein the free layer comprises first and second CoFe alloy sublayers and a Heusler alloy layer between and in contact with the first and second sublayers.

13. The head of claim 10 wherein each of the AP-pinned structures is a self-pinned structure.

14. The head of claim 10 further comprising a first antiferromagnetic layer exchange-coupled to the AP1 layer of the first AP-pinned structure for pinning the magnetization direction of the AP1 layer of the first AP-pinned structure, and a second antiferromagnetic layer exchange-coupled to the AP1 layer of the second AP-pinned structure for pinning the magnetization direction of the AP1 layer of the second AP-pinned structure.
